(19) United States
(12) Patent Application Publication
(10) Pub. No.: US 2025/0311884 A1
(43) Pub. Date: Oct. 9, 2025

(54) COOKER WITH AGITATION

(71) Applicant: SPECTRUM BRANDS, INC., Middleton, WI (US)

(72) Inventors: Peter Alan Steiner, Madison, WI (US); Kroy Everett Nernberger, Madison, WI (US); Vignesh Manikandan Pirathaban, Madison, WI (US)

(21) Appl. No.: 18/628,584

(22) Filed: Apr. 5, 2024

(51) Int. Cl. A47J 36/16; A47J 36/24; A47J 36/32

(52) U.S. Cl. CPC A47J 36/165; A47J 36/2483; A47J 36/32

(57) ABSTRACT

An electric cooking appliance includes a cooking vessel, an electric heating unit, and an operational unit. The operational unit includes an electric motor, a rotary drive feature operably driven by the motor, and a housing configured to interface with the cooking vessel. A stirring blade is operatively connectable to the rotary drive feature and configured for processing a food product during rotation. The cooking vessel has a base and is provided with at least one fixed agitation assisting feature located at a point along a circumference of an outer boundary of a swept path of the stirring blade when installed, and the fixed agitation feature configured to interact with the stirring blade during operation to provide rotational interplay between the stirring blade and the fixed agitation assisting features at the outer boundary, where a resulting resistance is created such that a processing of the food product during operation is improved.

### TECHNICAL FIELD

The present application relates to cooking appliances that can cook in a variety of cooking modes and settings, and more particularly to a cooking appliance with agitation features and related functionality.

### BACKGROUND

Cooking appliances come in various configurations and types, and can be powered by electricity in domestic or commercial settings. Some types of cooking appliances include slow cookers, multi-cookers, roasters, fryers, grills, steamers, and the like. Some cooking appliances, such as multi-cookers, can provide functionality of one or more cooking appliance types in a single appliance, and can incorporate heating and/or rotational mixing control functionality that permits specialized cooking aspects. In some cases, accessories and/or parts are exchanged for using a multi-purpose heating unit, base unit, power unit, and/or control unit.

Existing multi-cookers typically have difficulty with mixing, breaking apart, stirring, and/or shredding aspects, such as for shredding meat that is being slow cooked. Typical multi-cookers also have a cooker body and bowl inside the body that is smoothed or rounded, and cooking is done without agitation or with only a basic stirring feature. Therefore, an imperfect mix and/or consistency can result. Therefore, there is a need for a cooker with improved agitation aspects.

### SUMMARY

Aspects of the invention described herein are directed to cooking appliances that are designed to improve processing, including shredding and agitation, associated with slow cooking modes, while having maximum functionality and providing easy-to-clean parts by an end user. An example cooking appliance can be an electric slow cooker that includes a cooking vessel that can be easily cleaned, in contrast to other such cookers. Digital or mechanical control components, and associated heating controls are contemplated. Manual or automatic inputs are also contemplated, with or without advanced control logic. Various cooking modes and settings are contemplated. Furthermore, various digital displays can be used, or a knob, buttons, or a dial can be utilized.

The cooking appliance can include separable parts that allow for cleaning or washing some parts only without affecting others. A removable stirring blade is provided inside a passive cooking vessel and the stirring blade is driven by a shaft or other coupling feature, e.g., of an active operational unit (a base unit or powered lid unit that includes power and control units). These active components can be completely separated so that the cooking vessel, which includes a bowl unit (e.g., a pot), can be submersible and easily washed without exposing control or power components to liquids during cleaning. Therefore, various parts of the cooking appliance, such as the stirring blade, vessel, and lid can be completely conveniently immersed in liquid or placed in a dishwasher for cleaning.

According to a first aspect of the present disclosure, an electric cooking appliance is disclosed. According to the first aspect, the appliance includes a cooking vessel, an electric heating unit, and an operational unit. The operational unit includes an electric motor, a rotary drive feature operably driven by the motor, and a housing configured to interface with the cooking vessel. The appliance further includes a stirring blade operatively connectable to the rotary drive feature and configured for processing a food product during rotation. According to the first aspect, the cooking vessel has a base and is provided with at least one fixed agitation assisting feature located at a point along a circumference of an outer boundary of a swept path of the stirring blade when installed, and the fixed agitation feature configured to interact with the stirring blade during operation to provide rotational interplay between the stirring blade and the fixed agitation assisting features at the outer boundary, where a resulting resistance is created such that a processing of the food product during operation is improved through the interplay.

According to a second aspect of the present disclosure, a cooking vessel is disclosed. According to the second aspect, the cooking vessel includes a bowl unit including a base with an interior configured to receive a rotary drive feature, the rotary drive feature defining a center point of a generally circular portion of the base. The base also has a secondary portion located along a periphery of the circular portion, the secondary portion including at least a vertically-raised fixed agitation assisting feature on the base configured to protrude into the secondary portion of the cooking vessel. Still according to the second aspect, the fixed agitation assisting feature has a profile that varies in radius relative to the center point along an arc in a horizontal plane.

According to a third aspect of the present disclosure, a rotatable stirring blade for use in a vessel of a heated cooking appliance is disclosed. According to the third aspect, the stirring blade includes a mounting portion configured to interface with a rotary drive feature of a cooking appliance at a proximal end thereof. The stirring blade further includes a generally elongate body having a length, the body having a height relatively greater than a width, where the length defines a swept path and outer boundary thereof. The stirring blade further includes a toothed distal end configured to contact food at the end during rotation such that the food is at least partially processed during operation.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 is a front perspective view of a cooking appliance, according to various embodiments.

FIG. 2 is a top perspective view of a removable vessel and lid of the cooking appliance of FIG. 1, according to various embodiments.

FIG. 3 is a bottom perspective view of the removable vessel and lid of the of the cooking appliance of FIG. 1, according to various embodiments.

FIG. 4 is a top perspective view of a base unit of the cooking appliance of FIG. 1, according to various embodiments.

FIG. 5 is another top perspective view of the base unit of FIG. 4, showing a stirring blade engaged with a drive shaft thereof, according to various embodiments.

FIG. 6 is a top perspective view of the cooking appliance of FIG. 1 with the lid removed to show an interior thereof, according to various embodiments.

FIG. 7A is a plan view of the cooking appliance as shown in FIG. 6, showing various mixing aspects and features thereof, according to various embodiments.

FIG. 7B is another plan view of the cooking appliance as shown in FIG. 6, showing various alternative mixing aspects and features thereof, according to various embodiments.

FIG. 8 is a plan view of the vessel of the cooking appliance of FIG. 1, according to various embodiments.

FIG. 9 is a perspective view of a vessel as shown in FIG. 8 further provided with a stirring blade, according to various embodiments.

FIG. 10 is a plan view of the vessel and stirring blade arrangement as shown in FIG. 9, according to various embodiments.

FIGS. 11A-11E show various views of the stirring blade and associated features, according to various embodiments.

FIG. 12 shows an example operational schematic of the cooking appliance, according to various embodiments.

FIG. 13 shows an example control panel of the cooking appliance, according to various embodiments.

### DETAILED DESCRIPTION

The methods and features described herein are applicable to cooking appliances, such as slow cooking appliances, and more specifically to cooking appliances that are provided with improved rotational processing aspects, including mixing, breaking apart, shredding, or agitation aspects. Described embodiments provide benefits including improved cooking and mixing, in particular for larger capacity vessels with heating and mixing, and simplicity of construction and operation. Various embodiments of cooking appliances are described herein, include slow cookers and multi-cookers with separable components to allow for easier cleaning, including dishwashing of certain components, such as a mixing blade and bowl unit and cooking vessel of the cooking appliance. An example cooking appliance is commonly-assigned to the present Applicant, Spectrum Brands, and is co-pending as U.S. Pat. App. Pub. No. US20230113939A1, the contents of which is hereby incorporated by reference for all purposes.

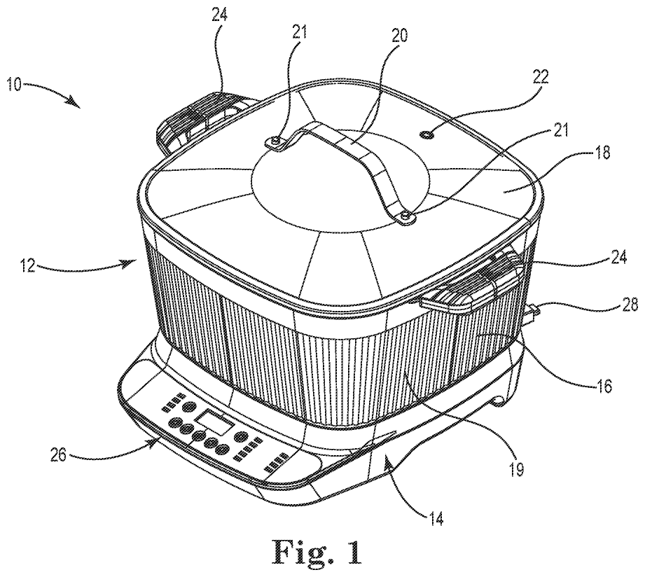

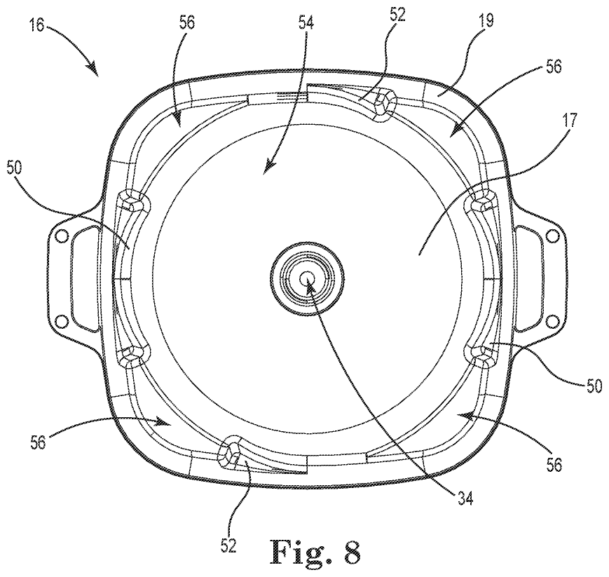

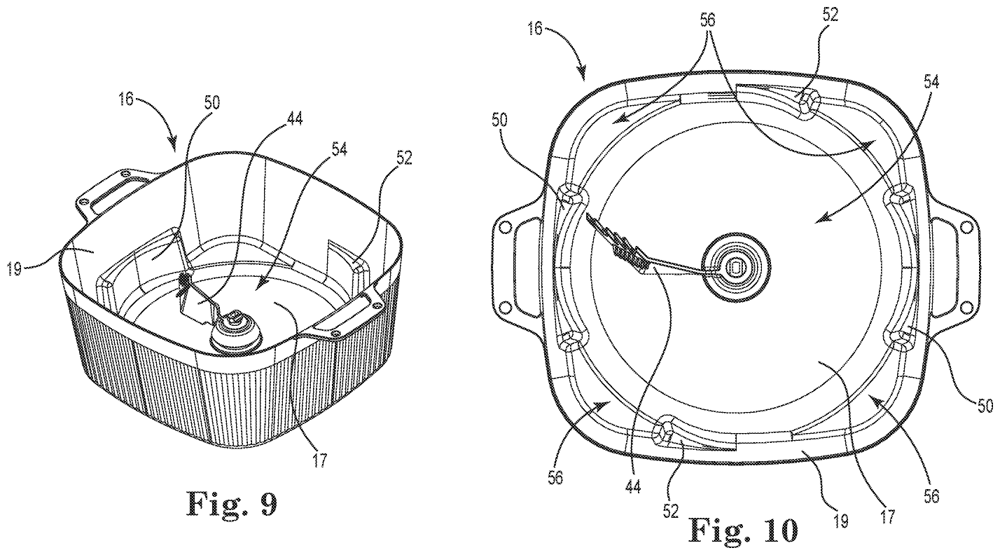

An example of a cooking appliance 10 in shown with respect to FIGS. 1-11E. As shown, the cooking appliance 10 is an example of an electric slow cooker with mixing, heating, and control features, and that has separable, modular components.

With reference to FIG. 1, the cooking appliance 10 generally includes a cooking vessel 12 that comprises a bowl unit 16, which is configured to be supported by a base unit 14 (an example of an operational unit), below. The bowl unit 16 of the cooking vessel 12 can be generally cylindrical (defined by a vertically-extending axis) or ovaloid in horizontal profile, or preferably generally rectangular with rounded corners and sides in horizontal profile as shown. Other shapes and configurations are also contemplated. The bowl unit 16 is configured to receive and hold a food product (not shown), including liquid, semi-solid, and/or solid food products, and can have a preferred capacity and internal volume of approximately seven liters (or seven US quarts), or more or less depending on configuration. When assembled as shown, the cooking vessel 12 is preferably substantially liquid tight.

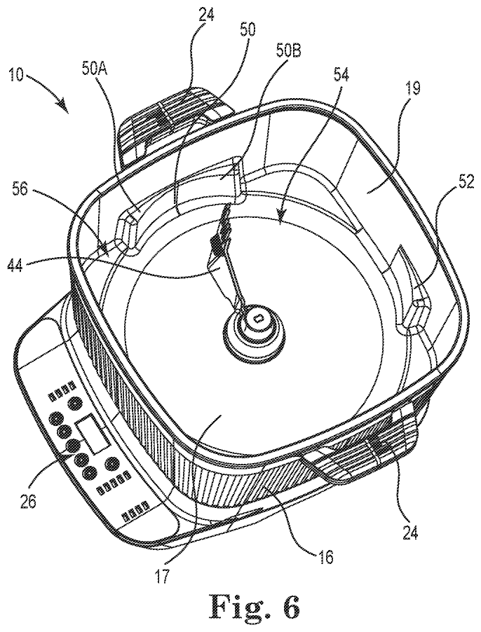

The cooking appliance 10 includes a cooking vessel 12 having a floor 17 (FIG. 6), the base unit 14 being provided with a heating unit 38, and a stirring blade 44, which, as shown, is removably keyed so as to be rotationally-fixed with and mounted to a drive shaft 40 of the base unit 14. Alternatively, the cooking vessel 12 itself includes an intermediate, detachable feature (e.g., part of the drive shaft 40) (not shown), which can be keyed or otherwise configured to interface with the drive shaft 40 or other drive component of the base for rotational operation, and such drive feature can be intended to remain with the cooking vessel 12 when the various components are disassembled. Various seals, grommets, and the like can be included to create a liquid-tight seal where the intermediate shaft rotates and passes through the cooking vessel floor 17.

The driven stirring blade 44 is caused to be rotated during operation to create a beneficial agitating, stirring, mixing, breaking apart, and/or shredding effect (collectively, “processing”) to a food product being processed during a rotation of the stirring blade 44 proximate at least one laterally-positioned, fixed agitation assisting feature 50/52 preferably associated with and/or integrated with the floor 17 of the bowl unit 16. As the cooking vessel 12 is separable from the base unit 14, a user can easily separate the relevant portions of the cooking appliance 10 that may require cleaning without requiring also placing other portions in the dishwasher, for example.

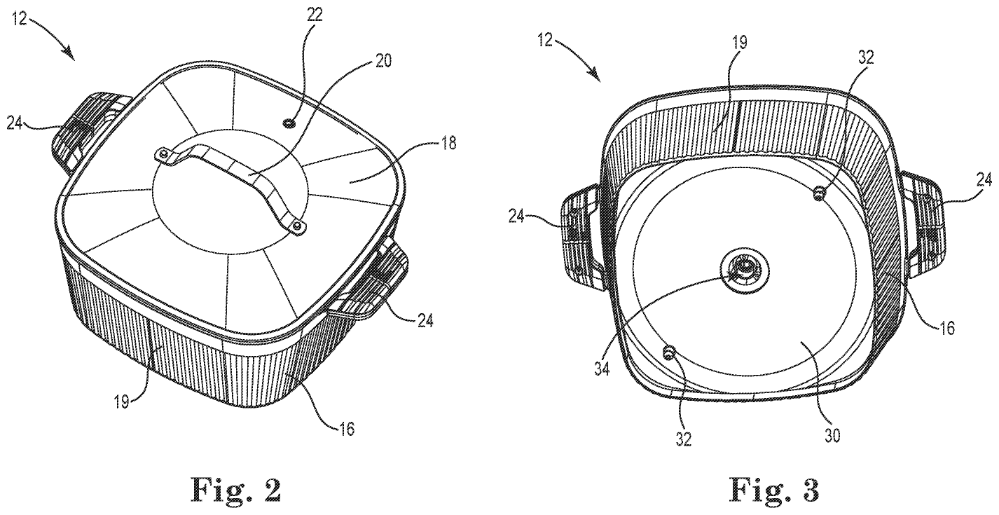

The bowl unit 16 of the cooking vessel 12 (in embodiments where a portion of the drive shaft 40 is not included with the cooking vessel 12) can be provided with a central opening 34 through a base 30 (defining an interior floor 17) thereof, and is configured to interface with and be supported by the base unit 14 of the cooking appliance 10, as described in greater detail below. A removable lid 18 with an aperture 22 (see, e.g., FIG. 2) when placed upon an upper rim of the bowl unit 16 at least partially covers an interior 54 of the bowl unit 16 otherwise exposed at an open top of the bowl unit 16. As shown in this embodiment, the lid 18 is passive. As discussed herein, in alternative top-driven embodiments, the lid 18 can include a motor, a downward-protruding drive shaft or coupling element for a top-driven drive shaft, and/or other operative parts described with respect to the base 14 adapted for incorporation above the stirring blade 44, herein.

Bowl handles 24 for grasping and lifting of the cooking vessel 12 of the modular cooking appliance 10 can be located at opposite distal ends of the cooking vessel 12 (e.g., of the bowl unit 16). As described in greater detail below, each fixed agitation assisting feature 50/52 is provided at a point along a circumference of an outer boundary of a swept path 58 of the stirring blade 44 when installed. Each fixed agitation feature 50/52 is configured to interact with the stirring blade 44 during operation to provide rotational mixing interplay, such as an agitation, squeezing, resistance, or the like, between the stirring blade 44 and the fixed agitation assisting features 50/52 at the outer boundary. Advantageously, a resulting rotational processing (e.g., shredding) effect is created such that a processing of the food product during operation is improved through the interplay, especially at locations around features 50/52 located or near the floor 17 of the bowl unit 16.

As shown best with reference to FIGS. 1 and 6, the lid 18 is removable from a resting position upon an upper rim of the bowl unit 16 of the cooking vessel 12. The lid 18, when installed or removed, can selectively expose or cover the interior 54 of the bowl unit 16. With the lid 18 at least partially removed from the bowl unit 16, a user can then add or remove food to/from the cooking vessel 12 accordingly. Lid 18 preferably includes a handle 20 and optionally includes an aperture 22, which can be configured to receive a temperature probe in certain embodiments. The handle 20 can be textured in order to improve gripping characteristics. The lid 18 can comprise a lid hanger, e.g., the handle 20, itself. Aperture 22 can further include a grommet fitted to the aperture 22. The grommet can be silicone, rubber, or any other elastomeric substance. Lid 18 can be transparent and can comprise glass for other non-handle 20 portions. The glass of lid 18 can preferably be tempered glass.

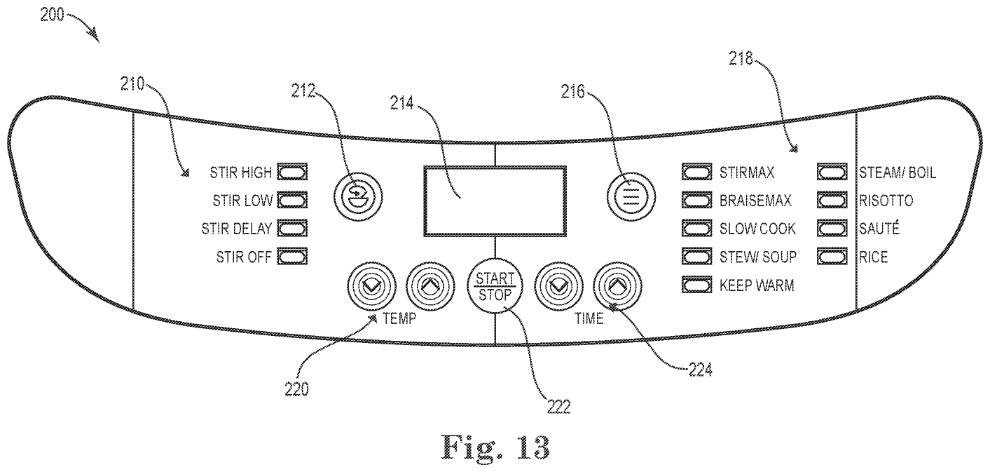

In some embodiments, the base unit 14 is configured to thermally insulate and/or separate the heated cooking vessel 12 and heating unit 38 from a supporting surface, such as a counter top or table. The base unit 14 can be composed of various plastics, metals, phenolic materials, or any other suitable material. The base unit 14, as shown, comprises a control unit 26 that protrudes from an outline of the cooking vessel 12, and provides a bezel for control knob in embodiments that utilize manual adjustments of control unit 26. An example control panel 200 for use with control unit 26 is shown with respect to FIG. 13, described further below. Also shown is a portion of a power connection 28 that connects the control unit 26 and heating unit 38 to a wall power outlet via a plug (not shown). The power connection 28 can be fixed to the base unit 14 or removable in various embodiments. In certain embodiments in which the bowl unit 16 itself comprises a heating unit, the power connection 28 can be optionally removably connected (e.g., via a plug) to a heating element, such as a Calrod resistive heating element, which can be embedded in or associated with the bowl unit 16.

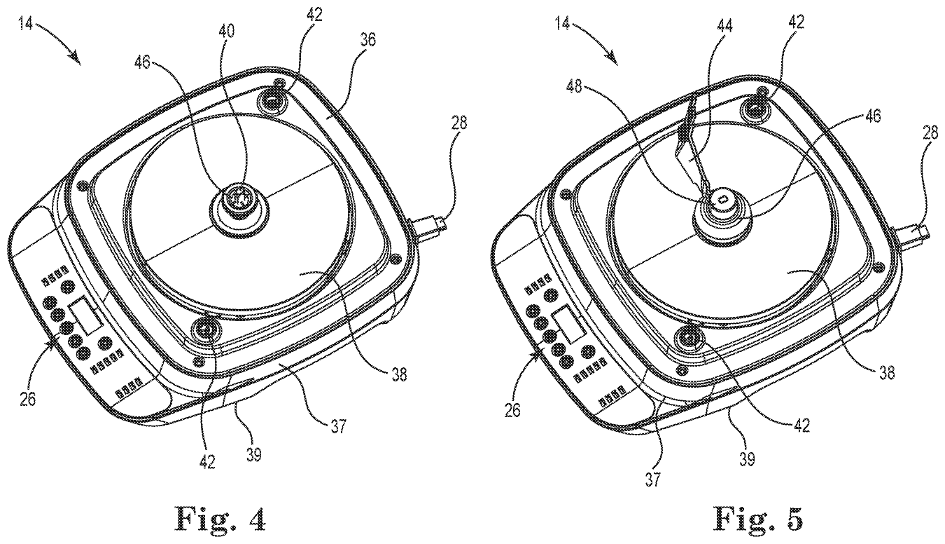

As shown in FIGS. 4 and 5, the base unit 14 (as shown configured for a bottom-driven stirring blade 44) is provided with a vertically-extending drive shaft 40 that protrudes vertically above a generally planar surface formed by the heating unit 38 and preferably that penetrates the central opening 34 of the bowl unit 16 when assembled. The drive shaft 40 is preferably keyed or otherwise provided with a spline or other feature for removable connection and driving of the stirring blade 44, either directly or through an intermediate shaft (not shown) of the cooking vessel 12 itself. Preferably, the stirring blade 44 is attached to the drive shaft 40, whether from above or below (as shown), using a friction or press-type fit coupling. In other embodiments, a threaded, bayonet, snap-fit, retaining clip, or other attachment arrangement is contemplated.

While shown in FIG. 5 attached to the drive shaft 40 without the bowl unit 16 in place, it is generally understood that the stirring blade 44 is preferably attached to the drive shaft 40 when the bowl unit is place on the base unit 14, and the drive shaft 40 (or intermediate shaft) protrudes through the opening of the base 30 of the bowl unit 16. After the bowl unit 16 is positioned on the base unit 14, the stirring blade 44 is then preferably attached prior to use (and the reverse is true for disassembly). As also shown in FIGS. 4 and 5, the stirring blade 44 can by further provided with a retaining ring 46 and a sealing cap 48. The sealing cap 48, also optionally used with the intermediate shaft embodiment, is advantageous over existing stirring cookers as the sealing cap 48 can hold the stirring blade 44 in place. For example, when a user tips the cooking vessel 12 so as to dump out food, the sealing cap can hold the stirring blade 44 such that it is retained within the cooking vessel 12 and does not fall out with the food. The sealing cap 48 also preferably keeps the stirring blade 44 in place during operation, including preventing it from getting dislodged or pushed up, and becoming ineffective or disconnected from the drive shaft 40. Features 46 and 48 are optional and can provide preferable attachment, sealing, and other features for optimal operation.

The cooking appliance 10 of FIGS. 1-11E shows an embodiment where a stirring blade 44 is bottom-driven, although it will be understood that in other modes of operation, a top-driven embodiment (where such stirring blade 44 is driven from above) is also contemplated, as discussed further below.

As shown in FIGS. 4 and 5, the example base unit 14 is provided with housing defined by upper housing 37 and lower housing 39, which together with the heating unit 38, are configured to support and interface with the cooking vessel 12. Optionally, the upper 37 and lower 39 housing portions are connected together using fasteners, including screws, snap-fit fasteners, or the like. The upper 37 and lower 39 housing portions can form a clamshell type housing together when assembled. The base unit 14 preferably is configured to house active, heating, motor, power, and/or electronic aspects of the cooking appliance 10, and the cooking vessel 12 is itself preferably configured to be passive, or non-electronic/electric, in configuration. However, in alternative embodiments, the cooking vessel 12 can include a heating element or the like, optionally embedded therein.

Selected components of the cooking appliance 10 are selectively separable from one another by a user, as desired from time to time, e.g., for storage, cleaning, and the like. Components can be separable by simply lifting vertically, e.g., using one or more handles such as handles 24. Alternatively or additionally, various components can be fastened to one another in various embodiments. In particular embodiments herein, the cooking vessel 12 is separable from the base unit 14 after or at the same time that a stirring blade 44 and associated fasteners are removed from within an interior 19 of the bowl 16. The stirring blade 44 itself can also be considered to be passive as used herein, as it is driven by the drive shaft 40 of the base unit 14, and lacks electric or electronic aspects itself.

In particular, the bowl unit 16 of the cooking vessel 12 and the stirring blade 44 may become significantly dirty, stained, or soiled after single or multiple and/or extended uses in heated cooking. Therefore, it is desirable to easily remove the bowl unit 16 and stirring blade 44, preferably considered passive components, for cleaning after a contact with the food product during cooking operation. The cleaning can be beneficially conducted in an automatic dishwashing appliance or can be washed by hand in a kitchen sink. Even where the bowl unit 16 optionally includes a heating element therein, the bowl unit 16 and cooking vessel 12 thereof can be considered passive and can be safe for dishwashing when disconnected from the base unit 14 or other active components.

The control unit 26 of the base unit 14, which optionally protrudes from and is spaced horizontally beyond a base profile of the bowl unit 16 when the bowl unit 16 is placed in position for use. The control unit 26 can include various features including a user interface including an input device and optionally a display for use by a user, in addition to various analog and/or digital controls. The control unit 26 may comprise a number of components, including, buttons, a control knob, or other user-manipulated devices/displays. See control panel 200 of FIG. 13, below, for an example control layout. In alternative, top-driven, embodiments where the lid includes at least some active components, the control unit 26 can be housed within a lid unit example of the operational unit, and the bowl unit 16 can include a heating element, optionally embedded therein, e.g., of the equivalent heating unit 38.

The control unit 26, whether part of the base unit 14 as shown or as part of an alternative lid operational unit, can further include computing and control circuitry, including a microprocessor connected to a memory or other integrated circuitry, a power unit, and/or connectivity features configured to connect the various components, including the heating unit 38 and motor-driven drive shaft 40, which can all be mounted, directly or indirectly, to an upper 37 and/or lower 39 housing portions of the base unit 14. Within the base unit 14 can be internal power components (not shown). These components are preferably operatively connected to the contact-based, surface of the heating unit 38 in bottom-driven embodiments (as shown). The heating unit 38 can include an internal resistive-heating element (not shown), which is configured to conductively heat the bowl unit 16 via the base 30 thereof, so as to heat the food product held within the bowl unit 16. Embodiments that utilize automatic or digital control interfaces and logic are also contemplated herein, for example as shown in FIG. 13.

As discussed above, the cooking vessel 12 itself is also preferably removable from the base unit 14 for cleaning, serving, etc. The cooking vessel 12 can be held to the base unit 14 primarily by gravity in some embodiments, or the cooking vessel 12 and base unit 14 can be snapped or otherwise fastened together such as including mechanical fasteners, release mechanisms, or the like. For example, as shown in FIG. 5, fastening components, including sealing cap 48 and/or retaining ring 46 can help connect the stirring blade 44 to the drive shaft 40 of the base unit 14 can operate to hold various components together until desired removal.

The bowl unit 16 of the cooking vessel 12, as shown best with respect to FIGS. 6-10, has an interior 54, sidewalls 19, a floor 17 associated with the base 30, and handles 24 optionally integrated into the construction of the bowl unit 16. As shown in FIG. 3, the base 30 of the bowl unit 16 is optionally provided with a drive aperture at central opening 34. Alternatively, an intermediate shaft is provided at the base 30 of the bowl unit 16.

Still with reference to FIGS. 3-5, a detachable interface between a separable bowl 16/cooking vessel 12 and base unit 14 is contemplated. One or more generally downwardly-extending bowl feet or pins 32 (e.g., 4 as shown) are configured to interface with a counterpart female portion 42 (see, e.g., FIGS. 4 and 5) of the base unit 14 to stabilize positioning of the bowl unit 16 to the base unit 14, and/or to guide installation of the bowl unit 16 to the base unit 14 in a correct alignment and position by a user. In some embodiments, the bowl pins 32 are configured for gravity or friction fit to the corresponding female portions 42 of the base unit 14, and in other embodiments a mechanical fastener or the like can hold the bowl unit 16 to the base unit 14 until a user may desire to separate the components.

Each supporting foot or pin 32 of the bowl unit 16 can be substantially cylindrical and/or hollow and can interface with the corresponding opening and female portion 42 at an upper portion of the base unit 14. Alternatively, the pin 32 and/or the female portion 42 can be prismatic, frustoconical, pyramid-like, or other non-cylindrical shapes. Optionally, three or more pins 32 can be provided to beneficially serve both the purpose of stably supporting the base unit 14 on a resting surface, and also the purpose of providing a guiding female portion 42 for precise positioning of the bowl unit 16 and cooking vessel 12 with respect to the base unit 14. As shown, two pins 32 are provided. Each supporting pin 32 can include a corresponding female portion 42 such that the pin at least partially penetrates the base unit 14, and each female portion 42 can be shaped and configured to receive a corresponding bowl unit pin 32. In some preferred examples, each female portion 42 can have a frustoconical opening configured to receive a corresponding, complementary frustoconical bowl unit pin 32. A frustoconical interface can beneficially facilitate positioning and attachment of the bowl unit 16 to the base unit 14. Other corresponding female portion 42 and bowl unit pin 32 shapes and configurations are also contemplated herein.

A corresponding number of bowl unit pins 32 and female portion 42 are shown; however, any number of either is also contemplated. The female portions 42 can be independently provided without association with the corresponding pins 32. Preferably, the base unit 14 comprises at least one female portion 42 corresponding to each bowl unit pin 32. In preferable embodiments, one of the pins 32 is configured to engage a microswitch (not shown) in a corresponding female portion 42 of the base unit 14 when the bowl unit 16 is positioned on the base unit 14, such that a signal is sent to the base unit 14 that the respective pin 32 of the bowl unit 16 is inserted. If the microswitch is not engaged, a heating element of the heating unit 38 preferably is caused to remain deenergized or to deenergize during operation if the microswitch signals that the bowl unit 16 is removed without the user first indicating for operation to stop. In other embodiments, the bowl unit 16 can include one or more female portions that instead receive a corresponding standoff or pin from the base unit 14, among other possible combinations, variations, and alternative configurations.

The bowl unit 16 portion of the cooking vessel 12 can be of unitary construction and/or can comprise various layers and/or substances, enamel, aluminum (e.g., anodized), stainless steel, among various other materials and compositions. In certain embodiments, the bowl unit 16 is formed of cast aluminum, providing precise geometry. The bowl unit 16 is preferably formed of a substance that generally has a thickness of approximately 1-2 mm, or more or less depending on configuration. In some embodiments, a surface of the interior 54 of the bowl unit 16 is coated, with e.g., a non-stick coating, such as polytetrafluoroethylene (PTFE) or a ceramic coating, to reduce adhesion to a food product during cooking. With reference to FIG. 3-5, a lower portion of the base 30 of the bowl unit 16 is also preferably configured and shaped to at least partially conform to and contact a heating unit 38 of the base unit 14 that is shaped and contoured to substantially conform to the base 30 when the bowl unit 16 is in contact with the base unit 14, e.g., for conductive heating operation. Preferably the base 30 of the bowl unit 16 is thermally conductive. Such an arrangement allows the heating unit 38 and drive shaft 40 to be properly positioned for heating and mixing use of the cooking appliance 10.

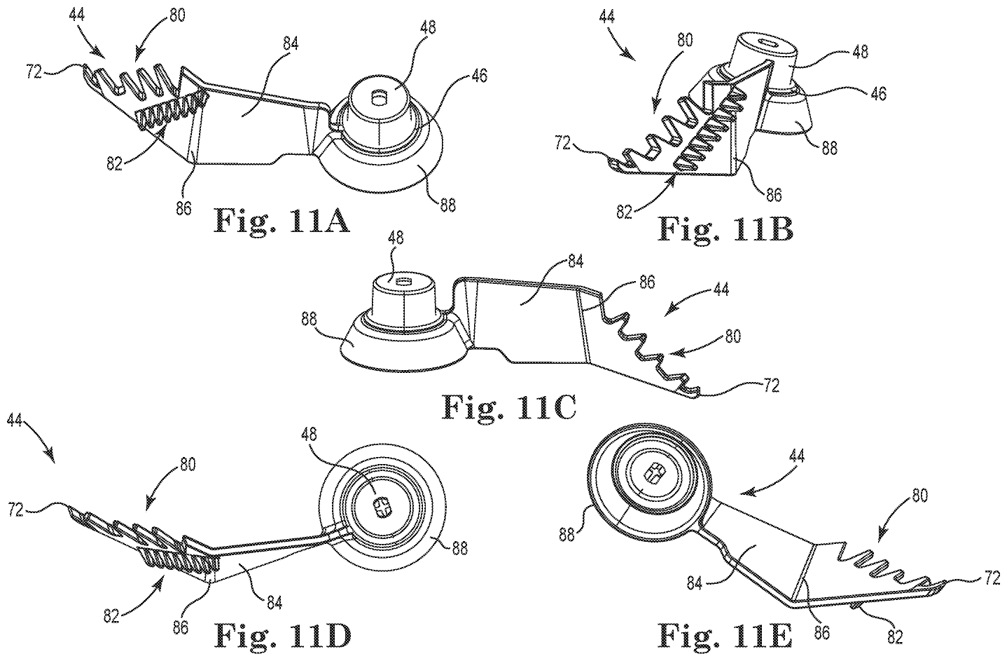

The cooking appliance 10 is preferably configured for both heating and stirring, optionally at the same time or different times, respectively, according to various programming settings and/or cycles. For rotational/stirring operation, and as described herein, the drive shaft 40 is powered by the electric motor housed in the base unit 14, operatively connects to the removable stirring blade 44, which is placed inside the bowl unit 16 and attached to the drive shaft 40 for operation. In certain embodiments, the drive shaft 40 is configured to vertically pass through the cooking vessel 12 at central opening 34 when the base unit 14 is interfaced with the cooking vessel 12, the drive shaft 40 further provided with an operative secure connection for mating with a removable stirring blade 44 and associated attachment features of cap 48 and retaining ring 48. In an alternative configuration, the base 14 is provided with a female coupler recess or opening, and the bowl unit 16 is provided with the intermediate drive shaft with a corresponding male coupler configured to removably interface with the female coupler of the base unit 14. The bowl unit 16 optionally has all rotational and drive shaft components sealed within it, such that the intermediate shaft of the bowl unit 16 can be inserted into the female coupler of the base unit 14 for operative connection. The stirring blade 44 is described in more detail in particular with respect to FIG. 11A-11E, below.

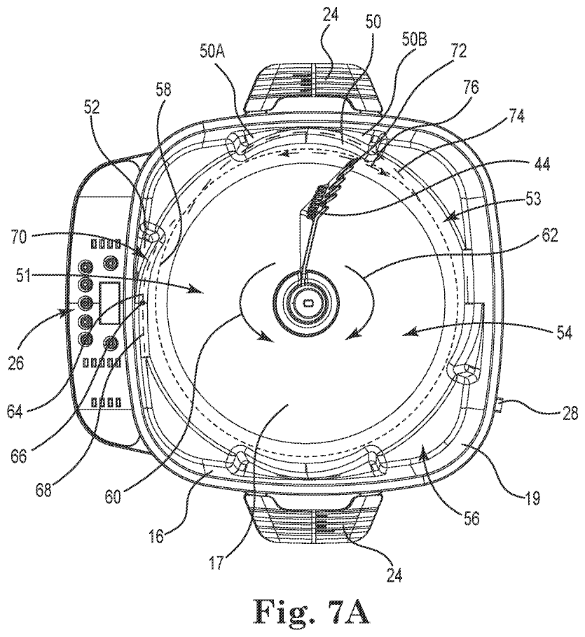

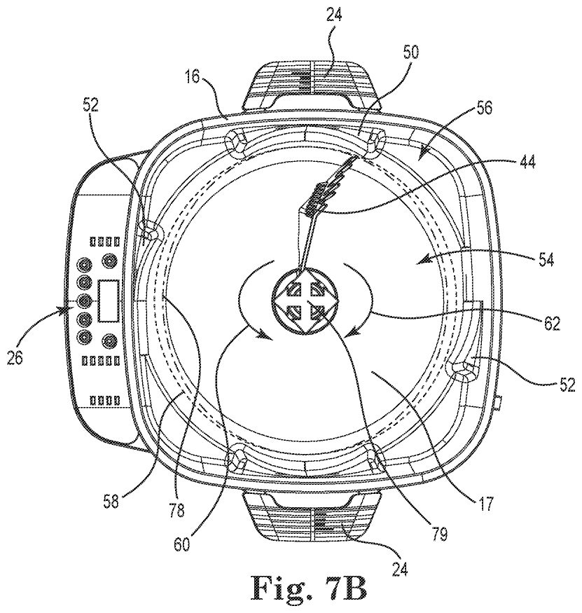

Referring now to FIG. 6, the bowl unit 16 of the cooking vessel 12 is also provided with one or more internal bumps or obstructions, referred to herein as fixed agitation assisting features 50 and 52, which are associated with and/or integrated with the floor 17 and/or sidewalls 19 of the bowl unit 16 of the cooking vessel 12. The central opening 34 preferably defies a center point of a generally circular, substantially flat portion of the floor 17. The floor 17 also has a secondary, outer portion 53 located along a periphery of the inner, “primary,” circular portion 51, which corresponds generally to a swept path 58 that is traversed by the stirring blade 44 during rotational operation. The secondary portion 53 includes areas outside the swept path 58, including corner regions (or cavities) 56 of the interior 54, and the secondary portion 53 includes at least one vertically-raised fixed agitation assisting feature 50/52 configured to be located in and/or protrude into the secondary portion 53 of interior 54. As shown and described with respect to FIG. 7A, discussed further below, each fixed agitation assisting feature 50/52 has a profile that varies in radius relative to the center point along an arc in a horizontal plane.

Still with reference to FIG. 6, the at least one fixed agitation assisting feature 50/52 preferably comprises a plurality of such features (e.g., one or more feature 50 and/or one or more feature 52) that together form a pattern around a periphery of the outer boundary of the swept path 58 of the stirring blade 44. Four features 50/52 are shown, although any number of features, or combination of features, is contemplated, including one, two, three, four, five, six, seven, either, nine, ten, or more features 50/52. Optionally, the plurality of features 50/52 comprises at least two profiles for interplay with the stirring blade, such as shown with features 50 and 52, such that at least two types of rotational processing (e.g., shredding, etc.) action occur along the outer boundary of the swept path 58 as the stirring blade 44 passes the various features.

During stirring operation, the at least one of the fixed agitation assisting features 50/52 guides and interacts with food being mixed as it also interacts at a portion of the swept path 58 and outer boundary defined by a blade tip 72 at a distal end of the stirring blade 44 (see also FIGS. 11A-11E). According to various embodiments, the at least one fixed agitation feature 50/52 is provided along the outer boundary of the swept path 58 of the stirring blade 44.

As discussed here, an interplay of the stirring blade 44 and the at least one fixed agitation assisting feature 50/52 is caused during operation and rotation of the stirring blade 44 relative to the features 50/52 of the cooking vessel 12. During example operation, a relative horizontal spacing between the stirring blade 44, including the blade tip 72 thereof, and the features 50/52 is caused to increase and/or decrease laterally based on a position within an arc of the swept path 58.

According to various embodiments, the cooking vessel 12 and bowl unit 16 thereof comprises a generally squared edge profile with rounded corner regions 56, and the feature(s) 50/52 include at least two integral raised features 50/52 located proximate relatively linear edges of the cooking vessel 12. During mixing operation, the corner regions 56 (e.g., four as shown) can permit the food product to gather for at least a time, which can further assist mixing and cooking operation. The corners regions 56 preferably also include a slanted surface configured to cause food to slide back into the center during or after agitation. The integral raised features 50/52 do not need to be the same distance from the center drive shaft 40 as they rise from the floor 17. For example, the integral raised features 50/52 could gradually or progressively recede away from the center of the bowl unit 16 or can be shaped like plateaus, as shown.

According to various embodiments, a first example of a fixed agitation assisting feature 50 has a curved inner profile 74 (see FIG. 7A) proximate the stirring blade 44 during operation and two sub-portions or elements 50A and 50B of the feature, which represent relative maxima in terms of a protrusion extension from the sidewall 19. According to various embodiments, the curved inner profile 74 of the feature 50 has a radius of curvature that is smaller than a radius of curvature of the swept path 58 as defined by the outer boundary thereof. The example feature 50 is preferably vertically raised from the floor 17.

A second example of a fixed agitation is shown at feature 52. In the shown example of FIG. 7A, the second feature 52 includes one protruding ramp feature at 70, with a curvature 64 associated therewith, and a non-curved portion 68 thereof, separated from curved portion 64 by point 66, as shown. As shown, opposite sides (laterally) of the bowl 16 can be provided with like types of features 50/52 in a same or similar fashion and defined to have a similar effect during mixing in a given rotational direction. In other words, features 50/52 on opposite sides of the bowl 16 can be rotationally symmetric as shown, or optionally reflectively symmetric in alternative embodiments. As discussed herein, both the first 50 and second 52 types of features preferably extend from (at least) the floor 17 of the bowl unit 16, and optionally extend to a height from the floor 17 that is less than the height of the bowl unit 16 itself. Moreover, an interaction between the stirring blade 44 and the features 50/52 preferably occurs at the floor 17, and thus preferably the features 50/52 are raised to a height from the floor 17 that is approximately equal to a height of the installed stirring blade 44, or less than or greater in height compared to the installed stirring blade 44.

With reference now to FIGS. 11A-11E, the rotatable blade 44 for use in the vessel of the heated cooking appliance 10 is shown and described in greater detail. The rotatable blade 44, as shown, is a single-arm configuration that includes a generally elongate body 84 having a length, the body 84 having a height relatively greater than a width, wherein the length, e.g., from a collar mounting portion 88 to the distal end of the blade tip 72, defines the circular swept path 58 and associated outer boundary thereof. Optionally, a multi-arm stirring blade 44 is also contemplated. As shown, the rotatable blade 44 includes a mounting portion 88, and retaining ring 46 and cap portions 48 associated therewith, which are configured to interface with a rotary drive shaft 40 at a proximal end thereof. As shown, the example rotatable blade 44 further includes one or more sets of shredding toothed features 80/82 located proximate the distal end of the blade tip 72, and preferably on opposite sides of the blade 44. Toothed features 80, as shown, are larger than the toothed features 82, and the blade tip 72 is preferably comprised within the first toothed features 80, as shown. Each set of toothed features 80/82 can include one or more individual teeth that are generally aligned and grouped to operate together. The various shredding, toothed features 80/82 are preferably configured to contact food at least at the blade tip 72 during rotation such that the food is at least partially processed, e.g., shredded, ripped, or pulled at least partially radially inward during mixing operation. According to various embodiments, the stirring blade 44 has a tapered profile such that a relatively smaller width portion at the distal end of blade tip 72 is relatively closest to a feature 50/52 during mixing operation.

According to other contemplated embodiments, the stirring blade 44 can be further provided with a flexible and/or scraping feature (not shown) on the blade tip 72 thereof, wherein the flexible feature is configured to directly contact at least one feature 50/52 during operation.

With regarding to cooking and mixing operation, and with reference again to FIG. 7A, the stirring blade 44 is configured to be selectively rotated clockwise 62 and/or counterclockwise 60 by controllably engaging the motor using various power inputs, timed inputs, and including optionally reactive/active control inputs based on detected operation, such as temperature level, stirring speed, etc. According to various embodiments, the rotation of the stirring blade 44 is configured to utilize a fixed time period forward (a first rotational direction) and the same fixed time period backward (a second direction opposite the first rotational direction) during an operation cycle. Due to the shape and configuration of the stirring blade 44 and/or the features 50/52, when the motor is energized, the stirring blade 44 is configured to push outward, radially, in a first direction and pull or scoop radially in a second direction. In various embodiments, the stirring blade 44 is angled to allow food to pass over the top of the stirring blade 44 when rotated counterclockwise 60, and to cause food to be trapped and forced into bumps when rotating in in the opposite, clockwise 62 direction (or vice-versa).

According to various embodiments, when the motor is energized, the stirring blade 44 is configured to laterally and indirectly interact with a feature 50/52 in a first way in a first rotational direction, and in a second way in a second rotational direction. According to various embodiments, a stirring setting is received from a user at the control unit 26, and operation is controlled based on the selection. The drive shaft 40 of the base unit 14 is also preferably powered by a motor (not shown) of any suitable type, including an AC or DC motor, such as an impedance-type motor, which can operate in a nominal thermal state even in a case of a jam or blockage situation. Optionally, a stir delay setting can be selected by a user or automatically, and such stir delay setting can be configured to start a stirring operation part way through the cooking cycle, e.g., after a previous heating or other delay. The motor and/or controller can optionally detect the presence of a food jam, and can cause a rotation or reversed rotation automatically when a detected load exceeds its maximum torque or when a detected rotational rate slows or stops.

With reference now to an optional embodiment shown in FIG. 7B, the stirring blade 44 is optionally translatably and/or flexibly connectable to the rotary drive shaft 40 such that the swept path 58 is caused to flex to an ovaloid/ellipse swept path 78, e.g., through an interaction and/or resistance with a food product and/or the sidewall 19 or features 50/52. In this example, outer boundaries and the swept path 78 of the stirring blade 44 are variable based on interactions of the stirring blade 44 with other features and/or food. An example of the two-dimensional, multi-directional flexibility 79 of the stirring blade 44 relative to the drive shaft 40 is also shown. The stirring blade 44 itself can optionally and/or additionally also include a flexibility aspect, including resilient and/or flexible construction.

The control unit 26 is preferably in operational engagement with the motor and power supply 28 for driving operation of the stirring blade 44 during cooking appliance 10 operation.

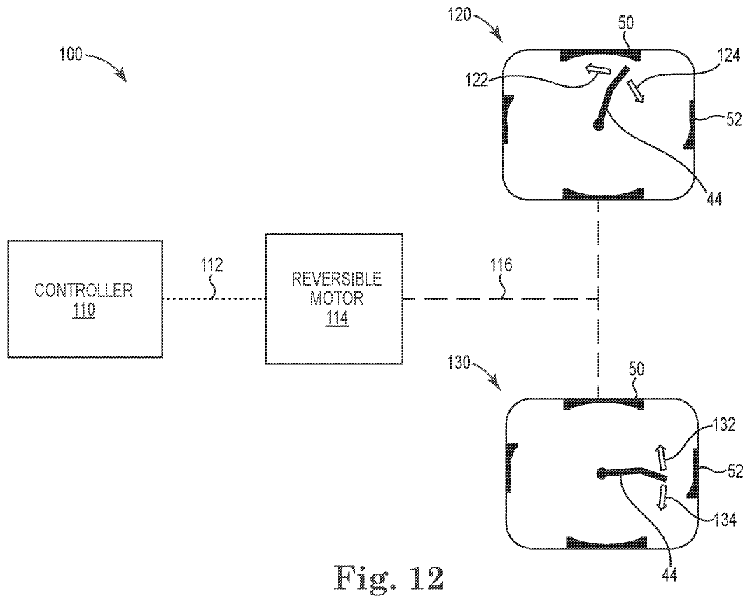

With reference now to FIG. 12, an example operational schematic 100 of the cooking appliance 10 is shown, according to various embodiments. As shown, a controller 110 (optionally a component of control unit 26) is electronically and operatively connected to a reversible electric motor 114 by an electrical connection 112. The reversible motor 114, an example of the motor discussed herein, is then mechanically and operatively connected to the stirring blade 44 as described herein by a mechanical connection 116.

Embodiments of the controller 110 include analog or digital control systems. The analog control components or digital control components contemplated herein can also comprise a combination analog/digital controller 110. The controller 110 can include various programmed or programmable cooking functions. For example, cooking functions and modes can include a slow-cooker setting with or without mixing or stirring, including timed and programmed forward and reverse pre-programmed stirring cycles, a higher-heat setting, a lower-heat setting, a roast setting, a sous-vide setting, a sauté setting, a sear setting, a rice setting, a boil setting, a manual temperature setting, a manual stirring setting, manual or automatic timed settings, among various other multi-cooker settings ranging from general to specific, fully manual to fully automatic, and the like.

For various functions of embodiments described herein, an on/off duty cycle can be selected through the control unit 26 for use with controller 110. The controller 110 can operate at least partially automatically according to various inputs, and can include one or more circuits, such as one or more microprocessors, memories, connections, or other circuitry. In such digital control unit various cooking functions and modes can be controlled from various firmware, software, and/or any programmable computer or electronic storage or processing components, etc. In some examples, the control unit 26 can lack a physical connection between the knob and the power unit. For an analog control unit 26 variation, various mechanical and/or analog components can provide a signal to the heating unit 38 and the power unit without the use of digital or computer-based components. Various components of the analog control unit can include various manual controls, mechanical linkages, switches, sensors, snap-action or thermally-activated components, analog circuitry, etc. Yet further embodiments can utilize some digital and some analog components in a control unit 26.

Control unit 26 can be construed broadly to comprise the controller 110, the control panel 200 (see FIG. 13), the power cord 28, the heating unit 38, and heating unit electrical leads used to selectively power the heating unit 38. Example control unit 26 can be partially integrated with the lower portion 39 in various embodiments. A digital control unit 26 can include a non-mechanical, linkage-free digital control between a control knob and power unit. The controller 110 can be configured to regulate power produced by the power unit. The power unit can interface with the heating unit 38 and the power cord 28. The power unit can receive alternating current electrical power via power cord 28 and transform/rectify (if necessary) alternating current to direct current for use with heating unit 38. The heating unit 38 can include a Calrod, quartz, or any other resistive heating element or unit can be used herein. In one embodiment, the heating unit 38 includes a Calrod heating element with a rating of 800 Watts or more, as powered by the power unit.

The controller 110 can optionally be programmed to detect a temperature during operation and use the detected temperature as an input to determine or modify a stirring program, such as an on or off setting, a speed, and/or a direction. For example, the controller 110 can be programmed to operate according to a risotto function, in which the controller 110 can cause the motor and stirring blade 44 to stir until the temperature is determined to exceed 212 degrees F. (100 degrees C.), e.g., when all the water has boiled off. Alternatively, the controller 110 can cause stirring in response to a temperature detected to reach a threshold, such as to avoid a burning of food being cooked.

Still referring to FIG. 12, two operational situations 120 and 130 are shown. In scenario 120, the stirring blade 44 is shown during an interaction with feature 50. In various embodiments, the motor 114 can cause the stirring blade 44 to rotate clockwise 124 or counterclockwise 122 as the stirring blade 44 passes and causes an interaction when proximate the feature 50. The stirring blade 44 and feature 50 can interact in a first way during clockwise 124 rotation, and in a second way during counterclockwise 122 rotation. In this way interactions between the stirring blade 44 and feature 50 can vary in scenario 120 based at least in part on the direction of rotation and which type of feature is being interacted with by the stirring blade 44. Operation can include clockwise 124 or counterclockwise 122 rotation for a time period or until certain conditions are met followed by one or more rotational cycles, optionally reversing in rotational direction each cycle. Optionally, rotational speed can be fixed or variable during each cycle.

In scenario 130, the stirring blade 44 is shown during an interaction with feature 52. In various embodiments, the motor 114 can cause the stirring blade 44 to rotate clockwise 134 or counterclockwise 132 as the stirring blade 44 passes and causes an interaction when proximate the feature 52. The stirring blade 44 and feature 52 can interact in a first way during clockwise 134 rotation, and in a second way during counterclockwise 132 rotation. In this way interactions between the stirring blade 44 and feature 52 can vary in scenario 130 based at least in part on the direction of rotation and which type of feature is being interacted with by the stirring blade 44. Operation can include clockwise 134 or counterclockwise 132 rotation for a time period or until certain conditions are met followed by one or more rotational cycles, optionally reversing in rotational direction each cycle. Optionally rotational speed can be fixed during each cycle.

FIG. 13 shows an example control panel 200 and interface of the cooking appliance 10, according to various embodiments. As described herein, the control panel 200 can form part of the control unit 26 of the base unit 14. Alternatively, in embodiments where the stirring blade 44 is top-driven or the like, the control panel 200 can be positioned at a base or on a lid of the cooking appliance 10. The control panel 200 can be configured to receive user input and can display various functions and a status of operation of the cooking appliance 10. As shown, the control panel 200 includes a primary display 214, as well as secondary settings displays, including a stirring mode display 210, and a cooking mode display at 218. Alternatively, displays 210, 214, and/or 218 can be formed as single display, two displays, or any number of displays or arrangements thereof. Each display can be lighted, and can include one or more LEDs, LCDs, OLEDs, or any other suitable display format.

A stirring mode can be selected at input 212 of the control panel 200, and the corresponding stirring mode can be indicated at display 210. A cooking mode can be selected at input 216, and the corresponding cooking mode can be indicated at display 218. Also provided on the control panel 200 are temperature controls 220, timing controls 224, and a start/stop control at 222. Additional and variations on the controls of the control panel 200 are also contemplated herein.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

What is claimed is:

1. An electric cooking appliance, comprising:
a cooking vessel;
an electric heating unit;
an operational unit, comprising:
an electric motor,
a rotary drive feature operably driven by the motor, and
a housing configured to interface with the cooking vessel;
a stirring blade operatively connectable to the rotary drive feature and configured for processing a food product during rotation; and
the cooking vessel having a base and provided with at least one fixed agitation assisting feature located at a point along a circumference of an outer boundary of a swept path of the stirring blade when installed, and the fixed agitation feature configured to interact with the stirring blade during operation to provide rotational interplay between the stirring blade and the fixed agitation assisting features at the outer boundary, wherein a resulting resistance is created such that a processing of the food product during operation is improved through the interplay.

2. The electric cooking appliance of claim 1, wherein the at least one fixed agitation assisting feature comprises a plurality of features that together form a pattern around a periphery of the outer boundary of the swept path of the stirring blade.

3. The electric cooking appliance of claim 2, wherein the plurality of features comprises at least two profiles for interplay with the stirring blade, such that at least two types of processing action occur along the outer boundary of the swept path.

4. The electric cooking appliance of claim 1, wherein the at least one fixed agitation assisting feature guides a portion of the swept path and outer boundary of the stirring blade during operation.

5. The electric cooking appliance of claim 1, wherein during the interplay of the stirring blade and the at least one fixed agitation assisting feature, a spacing therebetween is caused to increase and/or decrease laterally based on a position within an arc of the swept path.

6. The electric cooking appliance of claim 1, wherein the at least one fixed agitation assisting feature has a curved inner profile proximate the stirring blade during operation.

7. The electric cooking appliance of claim 1, wherein the at least one fixed agitation assisting feature is vertically raised from the base.

8. The electric cooking appliance of claim 1, wherein the cooking vessel comprises a generally squared edge profile with rounded corners, and the at least one fixed agitation assisting feature includes at least two integral raised features located proximate relatively linear edges of the cooking vessel.

9. The electric cooking appliance of claim 1, wherein the at least one fixed agitation feature is provided along the outer boundary of the swept path of the stirring blade.

10. The electric cooking appliance of claim 1, wherein the rotary drive feature comprises a drive shaft that extends vertically from the operational unit, and wherein the drive shaft is configured to vertically pass through the cooking vessel when the operational unit is interfaced with the cooking vessel, the drive shaft further provided with an operative rotary connection for mating with a removable stirring blade.

11. The electric cooking appliance of claim 1, wherein the stirring blade comprises at least one set of shredding teeth, and wherein the stirring blade is configured to be selectively rotated clockwise and/or counterclockwise by engaging the motor at controlled times.

12. The electric cooking appliance of claim 11, wherein the rotation of the stirring blade is configured to utilize a fixed time period forward and the same fixed time period backward during an operation cycle.

13. The electric cooking appliance of claim 1, wherein when the motor is engaged, the stirring blade is configured to push in a first direction and pull or scoop in a second direction, laterally.

14. The electric cooking appliance of claim 1, wherein when the motor is engaged, the stirring blade is configured to laterally interact with a feature in a first way in a first rotational direction, and in a second way in a second rotational direction.

15. The electric cooking appliance of claim 1, wherein the electric motor is an impedance-type motor.

16. The electric cooking appliance of claim 1, wherein the operational unit is a base unit, and wherein the base unit is configured to support the cooking vessel.

17. The electric cooking appliance of claim 1, wherein the stirring blade is configured to be driven from above.

18. The electric cooking appliance of claim 17, wherein the operational unit is a lid unit, and wherein the cooking vessel comprises a heating element of the heating unit.

19. A cooking vessel, comprising:
a bowl unit comprising a base with an interior configured to receive a rotary drive feature, the rotary drive feature defining a center point of a generally circular portion of the base;
the base also having a secondary portion located along a periphery of the circular portion, the secondary portion including at least a vertically-raised fixed agitation assisting feature on the base configured to protrude into the secondary portion of the cooking vessel; and
the fixed agitation assisting feature having a profile that varies in radius relative to the center point along an arc in a horizontal plane.

20. A rotatable stirring blade for use in a vessel of a heated cooking appliance, comprising:
a mounting portion configured to interface with a rotary drive feature of a cooking appliance at a proximal end thereof;
a generally elongate body having a length, the body having a height relatively greater than a width, wherein the length defines a swept path and outer boundary thereof; and
a toothed distal end configured to contact food at the end during rotation such that the food is at least partially processed during operation.
